(19) United States
(12) Patent Application Publication
(10) Pub. No.: US 2012/0281703 A1
(43) Pub. Date: Nov. 8, 2012

(54) APPARATUS, AN ASSEMBLY AND A METHOD OF OPERATING A PLURALITY OF ANALYZING MEANS READING AND ORDERING DATA PACKETS

(75) Inventors: Alex Omø Agerholm, Roskilde (DK); Jens Christophersen, Virum (DK)

(73) Assignee: NAPATECH A/S, Seborg (DK)

(21) Appl. No.: 13/513,329

(22) PCT Filed: Dec. 6, 2010
(86) PCT No.: PCT/EP2010/068961

§ 371 Date: Jul. 23, 2012

Related U.S. Application Data
(60) Provisional application No. 61/266,775, filed on Dec. 4, 2009.

(51) Int. Cl. H04L 12/56

(52) U.S. Cl. 370/394

(57) ABSTRACT

A system and a method of operating the system, the system having a plurality of data receiving elements each receiving data packets from a data connection and from another receiving element and forwarding the two data packets to another receiving element in a predetermined order. If, at a point in time, only one data packet is received, a period of time is allowed to elapse, and if a second data packet is received, the two packets are output in the order. If not, the received data packet is output.

The present invention relates to a manner of reading/analyzing data packets in parallel, ordering the packets and outputting these sequentially in the desired order.

In a first aspect, the invention relates to an apparatus for ordering and outputting a plurality of data packets received from a data connection in a predetermined order, the apparatus comprising a plurality of analyzing elements each comprising:
first means for receiving a data packet from the data connection,
second means for receiving a data packet from another analyzing element,
means for outputting the data packets received by the first and second receiving means, and
a controlling element comprising means for:
   at a point in time, determining whether a data packet has been received by the first and/or the second receiving means,
   if, at the point in time, a data packet has been received by both the first and the second receiving means, determining an order of the two data packets and instructing the outputting means to output the two data packets in the determined order, and
   if, at the point in time, a data packet has been received from only one of the first and second receiving means, waiting for a predetermined period of time and
      if, within or after the predetermined period of time, a data packet has been received by the other of the first and second receiving means, determining an order of the two data packets and instructing the outputting means to output the two data packets in the determined order,
      otherwise, after the predetermined period of time, instructing the outputting means to output the data packet received.

In the present context, the apparatus may be a single piece of hardware within a single housing or may be formed by a number of separate elements interconnected so as to exchange data. This exchange may be under any data transfer protocol, such as TCP, Ethernet, Bluetooth or the like, and using any type of data transfer, wired or wireless.

Also, the analyzing elements may be provided as separated pieces of hardware, such as each being embodied by a separate PCB, processor, FPGA or the like. Alternatively, the same PCB/processor/FPGA may form a multiple of the analyzing elements. Also, the controlling unit may be integrated into other parts of the analyzing element or may be a separate entity.

A data packet may be any type of a data unit to be transmitted on or transported by a network, data cable, data bus, trunk, or the like. Normally, a data unit conforms to one or more data standards, such as the Ethernet standard being an umbrella under which a number of different standards or data packet types exist, such as UDP and TCP data packets. A data packet usually has a number of different information items or types, such as address data, payload or the like, which are each positioned at well defined or known positions within the data packet. Such positions and types will typically differ from data packet type to data packet type, but usually, the data packet type, and thus the positions of individual contents thereof, may be determined from the actual data packet, where after the individual data items, such as address data and/or payload, may be derived, altered, and/or used in the analysis. The type or standard may be derived directly from the data packet, such as when a particular data item of the packet identifies the type/standard, or may be derived from data derived from the data packet, such as on the basis of recognition of types and positions of data items of the data packet and subsequently determination of type(s) or standard(s) of data packet in which such data may be found at such position(s).

In this context, the data connection may be any type of data transfer connection, such as a data cable or trunk, using any data transfer protocol and being wired and/or wireless, connected to a computer, a server, a network or a storage.

The data packets may be forwarded on the data connection and fed to the individual first means in any manner and using any distribution scheme or the like.

In the present context, the ordering of the data packets may be that in which the data packets are received from the data connection or fed to the data connection, such as the order in which data packets are read out from a storage via a data connection. This order preferably is determinable also from the data packets in order for the analyzing elements subsequently to be able to determine, from any two data packets, the relative positions of the data packets in the order and thus which of the data packets is to be output first.

Data packets may be ordered in a multiple of manners and for a number of reasons. Usually, data exchange between computers is a file transfer, TCP transfer, VoIP or the like, where the order of the individual packets is important. Usually, such transfers are called streams.

A stream of data packets normally is a sequence of data packets transmitted from a single transmitter to one or more receivers. These data packets relate to e.g. a single file or the like transmitted in smaller portions, being the payload of the packets. The transmitter and receiver, or any intermediate network elements, will usually then have addresses also represented in the packet. In addition, other stream identifying information may be present in the data packet, depending on the individual data packet standard.

Thus, a stream may be identified on the basis of e.g. the addresses and/or the stream identifying information, whereby, if used consistently, the same information may be derived, and any subsequent process may identify the stream merely from the information.

In another situation, data packets may be provided with information therein determining the order thereof, such as a sequence number or a time stamp. Thus, this information may be used for ordering the packets. The advantage of a time stamp is that any two packets may be ordered in relation to each other. The sequence number, when sequentially applied, further has the advantage that it, as it is described further below, is also possible to determine whether two packets are neighbouring in the sequence, or whether additional packet(s) is/are to be positioned between these two packets.

Multiple first means are used. However, these means may operate with different speeds or delays, e.g. due to the fact that data packets need not have the same size, whereby the order in which the analyzing elements receive the data packets may not correspond to that in which the data packets are output from the storage. Thus a re-ordering is desired in order for the apparatus to output the data packets in the desired order.

When a plurality of analyzing elements exists, parallel reading/de-queuing and/or ordering may be performed. Any number of analyzing elements may be used, such as 2, 3, 4, 5, 6, 7, 8, 10, 15, 20 or more. All these analysing elements may, as is described further below, be identical or nearly identical, or they may be instantiated or created as different circuits with different operations.

Naturally, the data packets may be transferred from the

connection/PC/server/network/storage to the individual first receiving means in any manner, such as via a wired and/or wireless data connection/bus using any desired public or proprietary protocol, such as Ethernet, Bluetooth, TCP, PCIe or the like. The first means may each directly receive the data packets from the connection, or the first means may be provided as a daisy chain, where data packets are forwarded along the daisy chain until reaching the correct first means.

A transfer of data packets between analyzing elements is performed by the second receiving means and the outputting means. This transfer may be carried out using any type of data transfer, wired or wireless, analogue or digital, serial or parallel, and under any protocol, such as Ethernet, Bluetooth, PCIe or other protocols used on a PC motherboard or between internal PC resources, or the like.

When receiving data packets in parallel, where different processing delays or transfer delays may occur, it is desired to be able to again order the data packets. According to the invention, at a point in time, a determination is made as to whether a data packet has been received by either both of the first and second means or only one thereof. If no data has been received, no action is required.

Naturally, as will also be described further below, this determination and the subsequent actions preferably are performed multiple times, such as periodically. Alternatively, the procedure may be run each time a data packet has been received.

If a data packet is received on both the first and second receiving means, these data packets may be output without delay, and the data packet being the first in the order is output first. Naturally, multiple data packets may have been received by one or both of the first and second means. In this situation, the determination is made between the first two data packets, the earliest of which is then output. Then, the determination may be made again with the first two data packets—i.e. the next one from the first or second means having received the “earliest” of the data packets, and so on.

If only a single data packet was received at the point in time, another data packet may be received from the other of the first and second means, which other data packet actually may be earlier in the order, if the delay in receipt along the path taken by this other data packet is longer than that taken by the received data packet. Thus, the already received packet is not output immediately, but the processing unit awaits, for a predetermined period of time, whether a data packet is received on the other of the first and second means. If so, the data packets are ordered and output as described above. If not, the already received data packet is output. Naturally, if a data packet is received from the other of the first and second means, the controlling unit needs not await the full period of time before outputting the data packets.

In general, the predetermined period of time may be selected as desired. A large period of time may require a large buffering memory but provide a higher probability of ordering all packets, whereas a lower period of time does the opposite. Presently, the predetermined period of time will be between 0 and 1000ms, such as between 0.1 and 100 ms, preferably 0.2 and 50 ms. As will be described further below, the predetermined period of time may differ between different analyzing elements.

Depending on the situation and set-up, the outputting means may output the data packets to the second receiving means of another analyzing element or to another element.

In one situation, a plurality of the analyzing elements are positioned in a daisy chain structure having two ends, a first analyzing element not receiving data packets from another analyzing element being positioned at one end, and a second analyzing element outputting the data packets from the daisy chain and to a receiving data connection being positioned at another end.

In this respect, a daisy chain is a set-up where the analyzing elements are adapted to forward the data packets along a linear structure, from analyzing element to analyzing element, like pearls on a string. Naturally, the data packets are all output from the daisy chain at one end thereof, and the analyzing element at the other end of the daisy chain does not receive data packets from another analyzing element but only the data connection.

In this manner, a parallel receiving/reading/de-queuing is performed while a single, serial/sequential outputting is performed of the data packets in the order. In this respect, it is noted that the outputting of the data packets to the receiving data connection may be carried out in a different manner or with a different type of data communication (such as protocol) than that between the analyzing elements. The receiving data connection may be any type of data connection, such as a wired or wireless connection, to any type of data network or to any type of computer, and using any known data communication type and protocol. Usually, the data connection is either a computer bus (such as a bus type used internally in computers) or an Ethernet connection to a computer network, WAN, LAN, WWW or the like.

In a particularly preferred embodiment, the predetermined periods of time of different analyzing elements are different. This typically will be due to the fact that the differences in delay in transmission of data packets from the data connection to the first and second receiving means of an analyzing element may be different from analyzing element to analyzing element. Preferably, especially in the above daisy chain example, the period of time increases with the number of analyzing elements positioned between the actual analyzing element and the second analyzing element. An example is one in which the same delay, d-link, may exist in all analyzing elements of receiving data packets in the first means from the data connection. Data packets received by the second means, however, will differ depending on the position of the analyzing element along the daisy chain. A delay, d-det, may be seen in an analyzing element for the analysis therein as well as the outputting of the data packet(s). Also, a packet received may already have been waiting. This particular situation is dealt with further below.

Thus, any analyzing element not being the first analyzing element, for example, may experience or expect a delay of d-det times the number of analyzing elements through which a data packet received by the second means may travel, as well as the delay, d-link, caused by the delay of the receiving analyzing element receiving the data packet from the data connection. In that respect, the delay of the data packet received on the first means is only d-link.

Then, the predetermined period of time may be selected as a difference, such as a maximum delay in transmission time of a data packet from the data connection to the first means of the analyzing element and the second means of the element.

In one embodiment, each analyzing element comprises means for analyzing the received packet(s) and deriving therefrom information for use by the controlling element. In the present context, an analysis may be a determination of certain values, situations, types, identities, or the like from data contained in the data packet. An analysis may or may not result in an altering of contents of the data packet, and any type of information in or of the data packet may be used in the determining means.

The derived information may be data/information directly copied or read from the data packet or may be data relating to e.g. a type of data packet or a standard to which the data packet conforms. The type or standard may be derived directly from the data packet, such as when a particular data item of the packet identifies the type/standard, or may be derived from data derived from the data packet, such as on the basis of recognition of types and positions of data items of the data packet and subsequently determination of type(s) or standard(s) of data packet in which such data may be found at such position(s).

The information may be used for determining whether the data packet belongs to a known stream of data packets and subsequently, information may be derived from multiple data packets of the same stream to e.g. determine relative positions of these data packets in the stream.

In this situation, it may be desired to have the outputting means be adapted to output the derived information together with the data packet, the second receiving means being adapted to also receive derived information relating to each received data packet. In this manner, the derived information may be re-used in the subsequent analysis element.

A number of exceptions exist where it may not be desired to have the controlling element wait, even though only a single data packet has been received. In one situation, the controlling element is adapted to store a position of a latest output data packet in the order and, if the data packet received has a next, neighbouring position in the order, instruct the outputting means to output the data packet. In this situation, it is derivable from the data packets the actual positioning thereof in the ordering. In one situation, this is possible when the data packets have consecutive/sequential sequence numbers where no numbers are missing. Another situation is that in which other data exists in a data packet identifying the neighbouring, previous or following data packet. In this situation, the sequence number of the latest output packet may be stored, and if the next packet in the sequence is received, this may be output without delay.

In a second situation, the controlling element is adapted to, when, within or after the predetermined period of time, a data packet has not been received by the other of the first and second receiving means, output corresponding information, the controlling means being adapted to, at a second point in time, when having a data packet from the second receiving means and no data packet from the first receiving means, instruct the outputting means to output the data packet without waiting. In this context, “without waiting” means that no delay is intended.

Then, if a data packet has been waiting at one controlling element, it may then be output without further delays in subsequent analyzing elements. The reason for this is that once delayed, the data packet, when received by the subsequent analyzing element, may be assumed to guaranteed be further along in the order than and any future data packets received by the analyzing elements.

Naturally, at the second point in time, when having a data packet from the second receiving means when this data packet has been waiting, and when a data packet from the first receiving means already has been received and is waiting, the ordering of these two data packets may be determined. If the data packet from the first receiving means is earlier in the order than that received from the second receiving means, both data packets may be output in the order. In this respect, the data packet from the first receiving means, even if set to wait, is output without further delay.

On the other hand, if, at the second point in time, a data packet from the first receiving means is waiting and is later in the order than that, which again has waited, from the second receiving means, the waiting data packet may remain waiting, unless it is the next packet in the order, in the situation where it is possible to determine this, as is described above. In the latter situation, both packets may be output in the correct order without further delay.

Preferably, as mentioned above, the controlling element is adapted to perform the determinations and instructions at a plurality of different points in time. The number of data packets output from the data connection may be very large, so that the determination and operation is desired over a prolonged period of time. Preferably, the determination in each controlling element is performed periodically, or the operation is simply started again once completed (looped). It is noted that the operations of the individual controlling elements need not be synchronized in any way.

In another aspect, the invention relates to an assembly comprising an apparatus according to the first aspect and a storage, the first means being adapted to read/de-queue data packets from the storage.

Naturally, the reading/de-queuing will depend on the storage and the manner in which the data packets are stored in the storage. Preferably, as will be described further below, the data packets are stored in a queue. In this manner, the address of the next data packet to read/de-queue may be identified by a pointer which is subsequently updated to again point to the next data packet to de-queue.

Alternatively, the data packets may be stored in a linked list where each “link” comprises a data packet and the address of the next link. Or the addresses of the data packets are stored in a separate storage or a separate part of the storage. The data packets may be stored in the desired order or not.

In this situation, preferably, the storage holds a plurality of data packets in a queue as well as information relating to two end point pointers of the queue, the first means being adapted to read and update at least one of the pointers. Thus, one pointer will point to the next data packet to be de-queued, and another pointer may point to the next position of storing a data packet in the queue. The read pointer may be used and updated by the analyzing element reading/de-queuing the data packet, and the write pointer may be updated by a process, CPU, computer, server, or an analyzing element, writing data packets to the queue. The pointers may also be stored in the storage and thus be available to the analyzing elements.

Preferably, all reading/de-queuing/updating of data in the storage is performed by DMA.

A third aspect of the invention relates to a method of ordering and outputting a plurality of data packets received from a data connection, the method comprising outputting the data packets in a predetermined order and operating a plurality of analyzing elements, each analyzing element:
receiving a first data packet from the data connection,
receiving a second data packet from another analyzing element,
outputting the first data packet and the second data packet, the outputting step comprising
   at a point in time, determining whether a first and/or a second data packet has been received,
   if, at the point in time, both a first and a second data packet has been received, determining an order of the first and second data packets and outputting the first and second data packets in the determined order,
   if, at the point in time, only a first or a second data packet has been received, waiting for a predetermined period of time and
      if, within or after the predetermined period of time, another of the first and second data packets has been received, determining an order of the first and second received data packets and outputting the first and second data packets in the determined order,
      otherwise, after the predetermined period of time, outputting the data packet received.

As mentioned above, the receiving, reading or de-queuing of a data packet from the data connection, preferably a storage, will depend on how the data packets are output or e.g. stored in the storage. However, any known transmission storing/reading/de-queuing techniques may be used as may any known manners of data communication, both between the analyzing elements and the connection/storage, between individual analyzing elements, and when outputting data from the analyzing elements.

As is mentioned above, the ordering of the packets is that in which the data packets are output/read/de-queued. Naturally, the data packets may be stored in a storage and output in a particular order, but this is by no means required.

In one situation, a plurality of the analyzing elements are positioned in a daisy chain structure having two ends, a first analyzing element not receiving data packets from another analyzing element being positioned at one end, a second analyzing element outputting the data packets to a receiving data connection being positioned at another end. Thus, the all-but-one analyzing elements may have different output means compared to the remaining analyzing element, or the data communication between the analyzing elements and out of the remaining analyzing element may be the same. Alternatively, the analyzing means may be adapted to output data packets using multiple protocols.

Thus, a data packet received by the first analyzing element will be passed through all other analyzing elements before reaching the second analyzing element and being output therefrom.

Preferably, as is mentioned further above, the predetermined periods of time of different analyzing elements are different. Preferably, the period of time increases with the number of analyzing elements positioned along e.g. the daisy chain between the actual analyzing element and the second analyzing element. In general, the period of time may increase with the number of analyzing elements through which data packets received by the actual analyzing element may travel.

As described above, it is desired that the step of analyzing the first data packet and deriving therefrom information for use by the determination of the outputting step. In this situation, it is preferred that the outputting step comprises outputting the derived information together with the first data packet, the receiving step comprises also receiving derived information relating to each received data packet. This information may be used in a subsequent analysis instead of re-deriving it from the data packet.

As mentioned, exceptions may exist where it is not desired to wait the predetermined period of time but output the data packet without delay. One such situation is one wherein the outputting step comprises storing a position of a latest output data packet in the order and, if a first or second data packet is received having a next, neighbouring position in the order, outputting that data packet.

Another situation is one wherein, when a first or second data packet has not been received within or after the predetermined period of time, corresponding information is output with the data packet, the outputting step comprising, at a second point in time, when having received a second data packet with corresponding information and no first data packet, outputting the received second data packet, preferably again with corresponding information without waiting. In this situation, the second data packet may be compared to any first data packet. If the first data packet is earlier in the order, it may be output without delay and before the second data packet. Alternatively, if the first data packet is later in the order and waiting, the second data packet may be output and the first data packet may be allowed to wait as if no second data packet was output.

Naturally, as receiving of data packets from the connection may be a process taking place over a prolonged period of time, if not constantly, the analyzing elements preferably are adapted to perform the determinations and instructions at a plurality of different points in time.

Preferably, the receiving step comprises reading/de-queuing data packets from a storage, and in particular when the storage holds a plurality of data packets in a queue as well as information relating to two end point pointers of the queue, the reading/de-queuing step comprising reading and updating at least one of the pointers.

In the following, preferred embodiments will be described with reference to the drawing, wherein

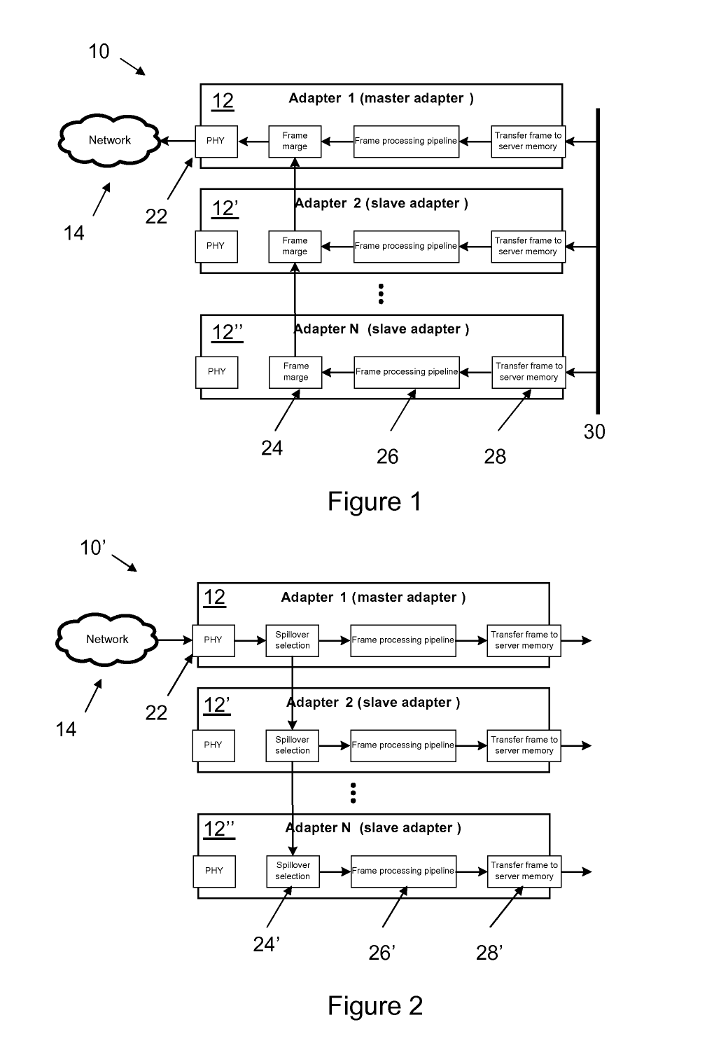

FIG. 1 illustrates an embodiment using only transmission of data packets,

FIG. 2 illustrates reception, analysis and storage of data packets and

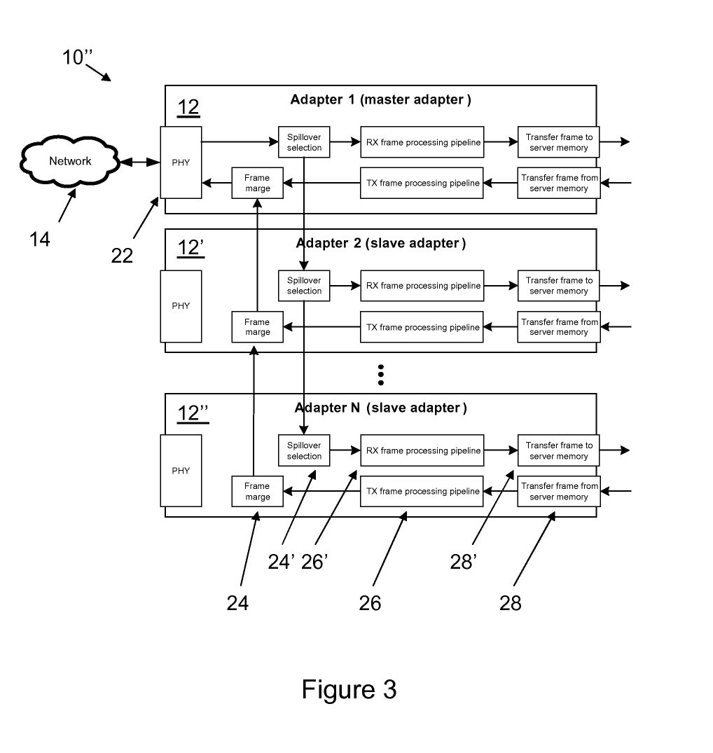

FIG. 3 illustrates a combination of the systems of FIGS. 1 and 2.

In FIG. 1, an embodiment of an assembly 10 is illustrated, in which a number of adapters 12 read, receive or de-queue data packets from a common data connection or data storage 30 of any type.

The data packets read/de-queued are fed to the connection 30 and/or read out from a queue of the storage 30 in an order in which the data packets are desired output from the adapters 12. However, the adapters, as will be described further below, are adapted to themselves determine the order or at least relative positions of data packets in the order.

A number of types of data transfer, such as file transfer, VoIP or the like, comprise exchanging a number of data packets which are output in a specific order and which are desired received and used in the same order. To that effect, the ordering of the packets should be maintained. In some situations, a position of a packet in this order may be determinable from the packet, or the relative positions of two packets in the order may be determined. In other situations, it is desired that the ordering is maintained by providing a time stamping (or simply a relative numbering) of receipt of the packet and maybe storing of the packets in a queue in the order of receipt (from the time stamps) or together with the time stamps so that the order of outputting may be derived from the ordering in the queue or from the time stamp stored in or with the data packets.

Thus, the address of a data packet or a time stamp or the like may also be transferred with the data packet to the individual adapter 12.

The adapters 12 comprise a transfer element 28 adapted to read or de-queue data frames from the data connection or storage 30. In one situation, the reading or de-queuing is handled by DMA, whereby a direct reading of the data packet is facilitated. In this situation, the transfer element 28 is aware of the actual address of the data packet. This address may be received from an area of the storage 30, in which the adapters 12 update addresses or pointers when de-queuing or reading data frames. Normally, the data frames are provided in queues, so that a read pointer is updated, when a data frame is de-queued. Also, a process or processor—or an adapter 12—may be adding data frames to the queue or data storage 30 and thus update addresses or pointers to indirectly inform the adapters 12 that more data has been added to the storage 30.

Having read the data packet, it is transferred to an analyzing element 26. Any type of processing or analysis may be performed. In one situation, the position of a packet in the ordering is determinable by contents of the data packet. This content may then be derived by the analyzing element 26.

In addition, other types of analysis not connected with the ordering of the data packets but with the contents thereof (receiver, transmitter, payload or the like) may take place. It is noted that no analysis is at all required.

The data packet is transferred to a merging unit 24. It is seen that the merging units 24 of the middle adapter 12′ and the top adapter 12 receive data frames both from the lower adapter 12′/12″ as well as from the adapter's own analysis element 26. The merging unit 24 of the lower adapter 12″ merely forwards the data packets received to the middle adapter 12.

In general, the merging units act to receive data packets from the lower adapter 12/12′ and the analysis elements and determine the order of such packets as well as to output the packets in the correct order.

It is noted that the merging unit 24 of the middle adapter 12′ does not receive all data packets and thus is not distracted by the fact that “holes” in the order of data packets exist. The data packets available are forwarded to the top adapter 12 in the correct order.

The operation of all merging units 24 may be the same and aims at ordering the packets received thereby.

In general, the merging unit 24 will, if having received a data packet from both the analysis element 26 and a lower-lying adapter 12′/12″ determine an order of the two data packets and output these in that order.

However, if only a single data packet is available, the merging unit 24 will wait a predetermined period of time. This may be due to different delays probably existing in data transfer from the connection or storage 30 to the merging unit 24 via the different possible channels. Naturally, any merging unit 24 may receive data packets from the pertaining analysis element 26. However, data packets may be received from a lower-lying adapter 12′/12″ which again may have received the data packet directly via the analysis element 26 or again from a lower-lying adapter. Thus, the higher the position of the adapter in the illustrated daisy chain, or the higher the number of possible adapters via which the present adapter may receive the data packet, the longer is the waiting period preferably.

In one situation, the delay experienced between two merging units 24 when receiving data packets directly from the channel/storage 30 may be 50-500 ns, such as 100-250 ns. The time delay in one merging unit 24 for analysis of a data packet and forwarding thereof may be on the order of 10-100 ns, such as 25-75 ns. Thus, the adapter 12′ may wait for e.g. 500 ns, while the adapter 12 may wait for e.g. 500+50 ns. If an additional adapter was provided higher than the adapter 12 in FIG. 1, this adapter could wait e.g. 500+50+50 ns.

If a data packet was received from the other of the lower merging unit 24 and the analysis element 26, no more waiting is required, and the outputting in the order is facilitated.

If no further data packet is received within the waiting period, the received data packet is output.

Thus, a local ordering takes place, while waiting to ensure that another data packet actually being earlier in the order is not received and then forwarded out of order.

Naturally, having waited for the set period of time, it is now ensured or assumed that the data packet is sufficiently delayed in the merging units 24 so that it is not required to have that data packet wait in the next merging unit 24 even if it is the only packet available. Thus, it is preferred that when a data packet has waited the full period of time of one merging unit 24, it is tagged accordingly and subsequently output without delay from the subsequent, higher-positioned merging units 24, of course in order with any available data packets. If a data packet is waiting in a subsequent merging unit 24, this data packet may be output immediately, if lower in the order than the received, tagged data packet. If the waiting data packet is higher in the order, it may keep waiting independently of the output of the tagged data packet.

Also, the merging units 24 may store the position in the order of a latest output data packet. This may be possible when the packets e.g. have a sequence number. In this situation, if a single, available data packet is received having the next number in the sequence, it is not required to wait the period in time, as it is certain that no other data packet earlier in the order may be received, and this data packet thus may be output without delay.

The data packets to be output from the merging unit 24 of the top analyzer 12, the so-called master adapter 12, are output to an external receiving data connection 14, such as to or via the WWW, using a standard PHY 22.

FIG. 2 illustrates a use of the same overall structure to receive, analyze and store data packets from the connection 14. In this embodiment 10′, the data packets are received by the PHY 22 and forwarded to a spill-over unit 24′. This spill-over unit 24′ will forward as many data packets to the analyzer 26′ or the transfer element 28′ of the master adapter 12, as the analyzer 26′/transfer element 28′ is able to handle. If more data packets are received, these are “spilled-over” to the spill-over unit 24′ of the next adapter 12′ which performs the same function, and so on.

As mentioned above, the ordering of the data packets received by the PHY 22 may be registered by time stamping the packets.

The analysis performed in the analyzers 26′ may be any analysis suitable, such as a pre-analysis of the packets before forwarding to a common storage, using the common connection or storage 30, from which processors/processes (not illustrated) perform additional analysis.

One type of analysis may be that of determining an address for storing the data packet in the storage 30.

The analyzed data packet is then stored, using a storing unit 28′, in a storage or simply output to a data connection.

In FIG. 3, the embodiments of FIGS. 1 and 2 are combined into a single embodiment 10″.

It is noted that all adapters 12 generally may be identical and may be provided as separate electronic circuits or provided in the same circuit.

The behaviour of the adapters, and in particular the master adapter 12 may be programmed in software or hardware for this adapter electronically to be identical to the other adapters. Alternatively, two or more different types of circuit may be provided.

1. An apparatus for ordering and outputting a plurality of data packets received from a data connection in a predetermined order, the apparatus comprising a plurality of analyzing elements each comprising:
first means for receiving a data packet from the data connection,
second means for receiving a data packet from another analyzing element,
means for outputting the data packets received by the first and second receiving means, and
a controlling element comprising means for:
at a point in time, determining whether a data packet has been received by the first and/or the second receiving means,
if, at the point in time, a data packet has been received by both the first and the second receiving means, determining an order of the two data packets and instructing the outputting means to output the two data packets in the determined order, and
if, at the point in time, a data packet has been received from only one of the first and second receiving means, waiting for a predetermined period of time and
if, within or after the predetermined period of time, as data packet has been received by the other of the first and second receiving means, determining an order of the two data packets and instructing the outputting means to output the two data packets in the determined order,
otherwise, after the predetermined period of time, instructing, the outputting means to output the data packet received.

2. The apparatus according to claim 1, wherein a plurality of the analyzing elements are positioned in a daisy chain structure having two ends, a first analyzing element not receiving data packets from another analyzing element being positioned at one end, and a second analyzing element outputting the data packets to a data connection being positioned at another end.

3. The apparatus according to claim 1, wherein the predetermined periods of time of different analyzing elements are different.

4. The apparatus according to claim 1, wherein each analyzing, element comprises means for analyzing the data packet received by the first means and deriving therefrom information for use by the determining means.

5. The apparatus according to claim 1, wherein the outputting means is adapted to output the derived information together with the data packet received by the first means, the second receiving means being adapted to also receive derived information relating to each data packet.

6. The apparatus according to claim 1, wherein the controlling element is adapted to store a position of a latest output data packet in the order and, if a data packet is received by the first or second means having a next, neighbouring position in the order, instruct the outputting means to output the data packet.

7. The apparatus according to claim 1, wherein the controlling element is adapted to, when, within or after the predetermined period of time, a data packet has not been received by the other of the first and second receiving means, output corresponding information, the controlling means being adapted to, at a second point in time, when having a data packet from the second receiving means and no data packet from the first receiving means, instruct the outputting means to output the data packet without waiting.

8. The apparatus according to claim 1, wherein the controlling element is adapted to perform the determinations and instructions at a plurality of different points in time.

9. An assembly comprising an apparatus according to claim 1 and a storage, the first means being adapted to read/de-queue data packets from the storage.

10. The assembly according to claim 9, wherein the storage holds a plurality of data packets in a queue as well as information relating to two end point pointers of the queue, the reading/de-queuing means being adapted to read and update at least one of the pointers.

11. A method of ordering and outputting a plurality of data packets received from a data connection, the method comprising outputting the data packets in a predetermined order and operating a plurality of analyzing elements, each analyzing element:
receiving a first data packet from the data connection,
receiving a second data packet from another analyzing element,
outputting the first data packet and the second data packet, the outputting step comprising
at a point in time, determining whether a first and/or a second data packet has been received,
if, at the point in time, both a first and a second data packet has been received, determining an order of the first and second data packets and outputting the first and second data packets in the determined order,
if, at the point in time, only a first or a second data packet has been received, waiting for a predetermined period of time and
if, within or after the predetermined period of time, another of the first and second data packets has been received, determining an order of the first and second received data packets and outputting the first and second data packets in the determined order,
otherwise, after the predetermined period of time, outputting the data packet received.

12. The method according to claim 11, wherein a plurality of the analyzing elements are positioned in a daisy chain structure having two ends, a first analyzing element not receiving, data packets from another analyzing element being positioned at one end, a second analyzing element outputting the data packets to a data connection being positioned at another end.

13. The method according to claim 11, wherein the predetermined periods of time of different analyzing elements are different.

14. The method according to claim 11, further comprising the step of analyzing the first data packet and deriving therefrom information for use by the determination of the outputting step.

15. The method according to claim 14, wherein the outputting step comprises outputting the derived information together with the first data packet, the step of receiving a second data packet comprises also receiving derived information relating to each received data packet.

16. The method according to claim 11, wherein the outputting step comprises storing a position of a latest output data packet in the order and, if a first or second data packet is received having a next, neighbouring position in the order, outputting the data packet.

17. The method according to claim 11, wherein, when, within or after the predetermined period of time, another of the first and second data packets has not been received, corresponding information is output with the data packet, the outputting step comprising, at a second point in time, when having received a second data packet with corresponding information and no first data packet, outputting the received second data packet without waiting.

18. The method according to claim 11, wherein the analyzing elements are adapted to perform the determinations and instructions at a plurality of different points in time.

19. The method according to claim 11, wherein the step of receiving the first data packet comprises reading/de-queuing the first data packet from a storage.

20. The method according to claim 19, wherein the storage holds a plurality of data packets in a queue as well as information relating to two end point pointers of the queue, the reading/de-queuing step comprising reading and updating at least one of the pointers.
